(19) United States
(12) Patent Application Publication
(10) Pub. No.: US 2023/0133463 A1
(43) Pub. Date: May 4, 2023

(54) ANODE FOR ALL-SOLID-STATE BATTERY AND MANUFACTURING METHOD THEREOF

(71) Applicants: Hyundai Motor Company, Seoul (KR); Kia Corporation, Seoul (KR)

(72) Inventors: Yoon Kwang Lee, Ansan (KR); Sang Heon Lee, Yongin (KR); Yun Sung Kim, Seoul (KR); Tae Hoon Hwang, Suwon (KR); Ga Hyeon Im, Gwangju (KR); Sa Heum Kim, Suwon (KR); Seung Ho Choi, Hanam (KR)

(21) Appl. No.: 17/960,925

(22) Filed: Oct. 6, 2022

(30) Foreign Application Priority Data
Oct. 28, 2021 (KR) 10-2021-0145295

(51) Int. Cl. H01M 4/583; H01M 10/0525; H01M 10/0562; H01M 4/04; H01M 4/134

(52) U.S. Cl. CPC H01M 4/583; H01M 10/0525; H01M 10/0562; H01M 4/0402; H01M 4/134; H01M 2300/0068; H01M 2220/20; H01M 2004/021

(57) ABSTRACT

Disclosed are an anode for an all-solid-state battery including an anode active material in which a metal that can form an alloy with lithium is deposited on all or a portion of the surface of a carbon-based material, and a method for manufacturing the same.

### CROSS-REFERENCE TO RELATED APPLICATION

This application claims under 35 U.S.C. § 119(a) the benefit of priority to Korean Patent Application No. 10-2021-0145295 filed on Oct. 28, 2021, the entire contents of which are incorporated herein by reference.

### TECHNICAL FIELD

The present invention relates to an anode for an all-solid-state battery including an anode active material in which a metal that can form an alloy with lithium is deposited on all or a portion of the surface of a carbon-based material, and a method for manufacturing the same.

### BACKGROUND

A lithium secondary battery includes cathode and anode materials that can exchange lithium ions and an electrolyte that is responsible for transport of the lithium ions.

A conventional battery includes a separator for preventing physical contact between a cathode and an anode for the purpose of preventing a short circuit. An all-solid-state battery is a system in which a solid electrolyte replaces the roles of the separator and a liquid electrolyte. Therefore, the all-solid-state battery has a remarkably low risk of explosion and thus has high safety. Further, since the solid electrolyte theoretically has faster ion transfer properties than the liquid electrolyte, the all-solid-state battery is promising as a next-generation high-power, high-energy battery.

Since all components of the all-solid-state battery have been made of solid, electrons and ions are transferred through the interparticle interface. Therefore, the interface between the materials dominantly influences the battery properties. In order to solve this problem, the transfer of ions and electrons at the interface should be controlled, and a reversible reaction of intercalation and deintercalation of lithium ions is required in the process. In particular, it is absolutely necessary to solve such a problem in graphite-based materials.

### SUMMARY OF THE INVENTION

In preferred aspects, provided is an anode for an all-solid-state battery having substantially improved lithium ion conductivity and storage properties. and having substantially improved energy density and lifespan characteristics.

The objects of the present invention are not limited to the objects mentioned above. The objects of the present invention will become more apparent from the following description, and will be realized by means described in the claims and combinations thereof.

In an aspect, provided is an anode including an anode active material containing a carbon-based material; and a solid electrolyte. The anode active material may include a deposition layer including a metal that can form an alloy with lithium and formed on at least a portion of the surface of the carbon-based material. The alloy formed by the metal and lithium is preferably such alloy that is stable at the use conditions, e.g., in battery operating conditions.

The anode active material may include a deposition layer formed on at least a portion of the surface of the carbon-based material that is in contact with the solid electrolyte.

The solid electrolyte may include a sulfide-based solid electrolyte.

The deposition layer may be deposited on a surface corresponding to at least about 90% of the entire surface of the carbon-based material.

The deposition layer may have a thickness of about 10 nm to 300 nm.

The metal that can form an alloy with lithium may include one or more selected from the group consisting of silver (Ag), magnesium (Mg), aluminum (Al), gallium (Ga), zinc (Zn), bismuth (Bi), tin (Sn), indium (In), antimony (Sb), lead (Pb), silicon (Si), and germanium (Ge).

The anode may further include a binder. The anode may suitably include an amount of about 80% by weight to 85% by weight of the anode active material, about 10% by weight to 15% by weight of the solid electrolyte, and about 1% by weight to 5% by weight of the binder. All % by weight is based on the total weight of the anode.

The anode may have a thickness of about 1 μm to 100 μm.

In an aspect, provided is an all-solid-state battery including: the anode as described herein; a cathode; and a solid electrolyte layer positioned between the anode and the cathode.

In an aspect, provided is a method for manufacturing an anode for an all-solid-state battery. The method may include the steps of: preparing a slurry including a carbon-based material-containing anode active material, a solid electrolyte, and a binder; and forming an anode by applying the slurry onto a substrate. The anode active material may include a deposition layer containing a metal that can form an alloy with lithium and formed on at least a portion of the surface of the carbon-based material.

The anode active material may include a deposition layer formed on at least a portion of the surface of the carbon-based material that is in contact with the solid electrolyte.

The solid electrolyte may include a sulfide-based solid electrolyte.

The deposition layer may be deposited on a surface corresponding to at least about 90% of the entire surface of the carbon-based material.

The deposition layer may have a thickness of about 10 nm to 300 nm.

The metal that can form an alloy with lithium may include one or more selected from the group consisting of silver (Ag), magnesium (Mg), aluminum (Al), gallium (Ga), zinc (Zn), bismuth (Bi), tin (Sn), indium (In), antimony (Sb), lead (Pb), silicon (Si), and germanium (Ge).

The anode may further include a binder. The anode may suitably include an amount of about 80% by weight to 85% by weight of the anode active material, about 10% by weight to 15% by weight of the solid electrolyte, and about 1% by weight to 5% by weight of the binder. All % by weight is based on the total weight of the anode.

In further aspects, vehicles are provided including the all-solid-state battery as disclosed herein.

According to various exemplary embodiments of the present invention, an anode for an all-solid-state battery may have substantially improved lithium ion conductivity and storage properties.

According to various exemplary embodiments of the present invention, an anode for an all-solid-state battery may have substantially improved energy density and lifespan characteristics.

The effects of the present invention are not limited to the above-mentioned effects. It should be understood that the effects of the present invention include all effects that can be inferred from the following description.

### BRIEF DESCRIPTION OF THE DRAWINGS

FIG. 1 shows an all-solid-state battery according to an exemplary embodiment of the present invention.

FIG. 2A shows an anode active material according to the present invention.

FIG. 2B shows a carbon-based material included in an anode active material according to an exemplary embodiment of the present invention.

FIG. 3 shows a role of an exemplary deposition layer according to an exemplary embodiment of the present invention.

FIG. 4 shows a result of analyzing an anode according to an Example with a scanning electron microscope (SEM).

FIG. 5A shows a first charge/discharge graph of a half-cell comprising the anode according to the Example.

FIG. 5B shows a first charge/discharge graph of a half-cell comprising an anode according to a Comparative Example.

FIG. 6A shows a high rate charge/discharge graph of the half-cell comprising the anode according to the Example.

FIG. 6B shows a high rate charge/discharge graph of the half-cell comprising the anode according to the Comparative Example.

FIG. 7 shows a result of measuring the lifespan of the half-cell comprising the anode according the Example.

### DETAILED DESCRIPTION

The above objects, other objects, features and advantages of the present invention will be easily understood through the following preferred embodiments related to the accompanying drawings. However, the present invention is not limited to the embodiments described herein and may be embodied in other forms. Rather, the embodiments introduced herein are provided so that the disclosed content may become thorough and complete, and the spirit of the present invention may be sufficiently conveyed to those skilled in the art.

The similar reference numerals have been used for similar elements while explaining each drawing. In the accompanying drawings, the dimensions of the structures are illustrated after being enlarged than the actual dimensions for clarity of the present invention. Terms such as first, second, etc. may be used to describe various components, but the components should not be limited by the terms. The terms are used only for the purpose of distinguishing one component from another component. For example, a first component may be referred to as a second component, and similarly, the second component may also be referred to as the first component, without departing from the scope of rights of the present invention. The singular expression includes the plural expression unless the context clearly dictates otherwise.

In the present specification, terms such as “comprise”, “have”, etc. are intended to designate that a feature, number, step, operation, component, part, or a combination thereof described in the specification exists, but it should be understood that the terms do not preclude the possibility of the existence or addition of one or more other features, numbers, steps, operations, components, parts, or combinations thereof. Further, when a part of a layer, film, region, plate, etc. is said to be “on” other part, this includes not only the case where it is “directly on” the other part but also the case where there is another part in the middle thereof. Conversely, when a part of a layer, film, region, plate, etc. is said to be “under” other part, this includes not only the case where it is “directly under” the other part, but also the case where there is another part in the middle thereof.

Unless otherwise specified, since all numbers, values, and/or expressions expressing quantities of components, reaction conditions, polymer compositions and formulations used in the present specification are approximate values reflecting various uncertainties of the measurement that arise in obtaining these values among others in which these numbers are essentially different, they should be understood as being modified by the term “about” in all cases. Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Further, when a numerical range is disclosed in this description, such a range is continuous, and includes all values from a minimum value of such a range to a maximum value including the maximum value, unless otherwise indicated. Furthermore, when such a range refers to an integer, all integers including from a minimum value to a maximum value including the maximum value are included, unless otherwise indicated. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

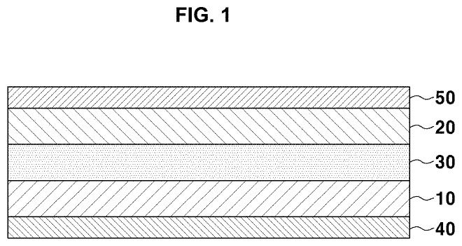

FIG. 1 shows an all-solid-state battery according to an exemplary embodiment of the present invention. As shown in FIG. 1, the all-solid-state battery may include an anode 10, a cathode 20, and a solid electrolyte layer 30 positioned between the anode 10 and the cathode 20. The all-solid-state battery may include an anode current collector 40 in contact with the anode 10 and a cathode current collector 50 in contact with the cathode 20.

The anode 10 may include an anode active material 11 including a carbon-based material, and a solid electrolyte 12.

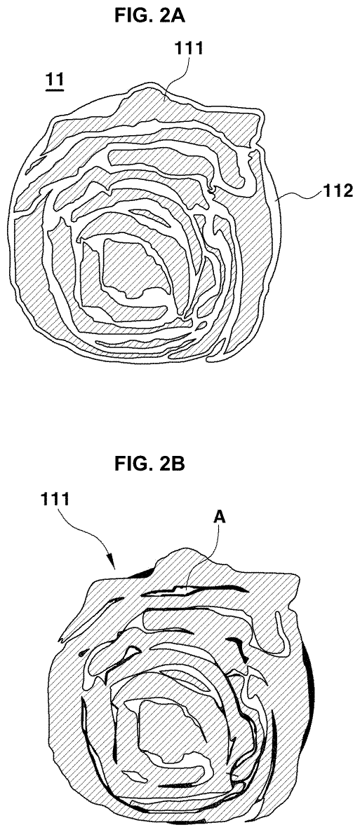

FIG. 2A shows the anode active material 11. FIG. 2B shows a carbon-based material 111 included in the anode active material 11.

The anode active material 11 may include the carbon-based material 111 and a deposition layer 112 deposited on the surface of the carbon-based material 111.

The carbon-based material 111 may perform intercalation and deintercalation of lithium when an all-solid-state battery is charged and discharged, and may include voids A therein.

The carbon-based material 111 may include any material as long as the material is commonly used in the art to which the present invention pertains. Examples of the carbon-based material 111 may include graphite such as natural graphite and artificial graphite, carbon nanotubes, carbon fiber, carbon black, Ketjen black, acetylene black, graphene, etc.

The shape of the carbon-based material 111 is not particularly limited, and may be a spherical shape, an oval shape, a plate shape, or the like.

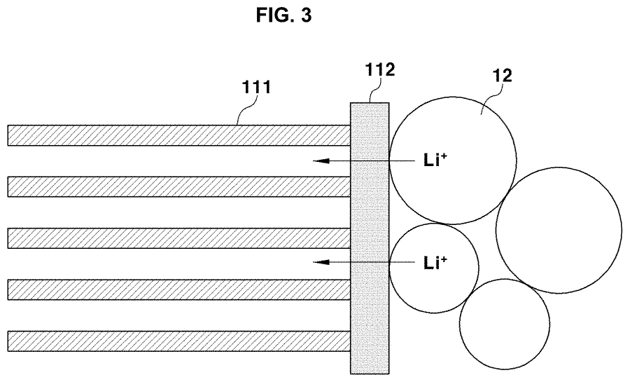

FIG. 3 shows a diagram for explaining the role of the deposition layer 112. For example, the deposition layer 112 may be deposited on at least a portion of the entire surface of the carbon-based material 111 that is in contact with the solid electrolyte 12.

The deposition layer 112 may include a metal that can form an alloy with lithium. The metal that can form an alloy with lithium may include one or more selected from the group consisting of silver (Ag), magnesium (Mg), aluminum (Al), gallium (Ga), zinc (Zn), bismuth (Bi), tin (Sn), indium (In), antimony (Sb), lead (Pb), silicon (Si), and germanium (Ge).

The deposition layer 112 may be present at the interface between the carbon-based material 111 and the solid electrolyte 12 to accommodate and reduce lithium ions (Li⁺) moving through the solid electrolyte 12 when the all-solid-state battery is charged. Accordingly, the lithium ions (Li⁺) may be deintercalated and intercalated in the form of lithium metal in the voids of the carbon-based material 111. In the conventional anode active material without the deposition layer 112, a side reaction layer may be formed at the interface between the anode active material and the solid electrolyte by oxidation/reduction reactions of carbon, sulfide-based solid electrolyte, lithium ions (Li⁺), and electrons. The side reaction layer may induce depletion of lithium in the battery and interferes with deintercalation and intercalation of lithium ions (Li⁺). Further, the side reaction layer may reduce the lifespan of the battery by inducing the formation of lithium dendrites on the surface of the solid electrolyte.

The deposition layer 112 may be deposited on a surface corresponding to at least about 90% of the entire surface of the carbon-based material 111. When the formation area of the deposition layer 112 is as high as the above numerical value range, the conductivity and storage properties of lithium ions may be improved.

The deposition layer 112 may have a thickness of about 10 nm to 300 nm. When the thickness is less than about 10 nm, a complete coating may not be made on the surface of the carbon-based material 111, and when the thickness is greater than 300 nm, problems arise in that the deposition layer 112 may be dominated by the properties of a metal active material to be coated, and it is difficult to produce materials.

A method for forming the deposition layer 112 is not particularly limited, and the deposition layer 112 may be formed by a method commonly used in the art to which the present invention pertains. For example, the deposition layer 112 may be formed by chemical vapor deposition (CVD), physical vapor deposition (PVD), or the like.

Examples of the solid electrolyte 12 may be an oxide-based solid electrolyte or a sulfide-based solid electrolyte. However, it may be preferable to use a sulfide-based solid electrolyte having high lithium ion conductivity.

The sulfide-based solid electrolyte may suitably include Li₂S—P₂S₅, Li₂S—P₂S₅-LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (provided that m and n are positive numbers, and Z is one of Ge, Zn, and Ga), Li₂S—GeS₂, Li₂S—SiS₂—Li₃PO₄, Li₂S—SiS₂—LiₓMO_{y} (provided that x and y are positive numbers, and M is one of P, Si, Ge, B, Al, Ga, and In), Li₁₀GeP₂S₁₂, etc.

The anode 10 may further comprise a binder. The binder may attach the anode active material 11 and the solid electrolyte 12.

The type of the binder is not particularly limited, and examples thereof may include butadiene rubber (BR), nitrile butadiene rubber (NBR), hydrogenated nitrile butadiene rubber (HNBR), polyvinylidene difluoride (PVDF), polytetrafluoroethylene (PTFE), carboxymethylcellulose (CMC), etc.

The anode 10 may suitably include an amount of about 80% by weight to 85% by weight of the anode active material, an amount of about 10% by weight to 15% by weight of the solid electrolyte, and an amount of about 1% by weight to 5% by weight of the binder, based on the total weight of the anode. However, the content of each component may be appropriately adjusted in consideration of desired capacity, efficiency, etc. of the all-solid-state battery.

The anode 10 may have a thickness of about 1 μm to 100 μm, about 25 μm to 100 μm, or about 50 μm to 100 μm. In particular, since the anode 10 according to the present invention has improved lithium ion conductivity, storage properties, etc. as described above. Therefore, the anode 10 can be manufactured into a thick film of 50 μm or more, which makes it possible to greatly increase energy density.

The cathode 20 may comprise a cathode active material, a solid electrolyte, a conductive material, a binder, and the like.

The cathode active material may be an oxide active material or a sulfide active material.

Examples of the oxide active material may suitably include rock salt layer-type active materials such as LiCoO₂, LiMnO₂, LiNiO₂, LiVO₂, and Li₁₊ₓNi_{1/3}Co_{1/3}Mn_{1/3}O₂, spinel-type active materials such as LiMn₂O₄ and Li(Ni_{0.5}Mn_{1.5})O₄, inverse spinel-type active materials such as LiNiVO₄ and LiCoVO₄, olivine-type active materials such as LiFePO₄, LiMnPO₄, LiCoPO₄, and LiNiPO₄, silicon-containing active materials such as Li₂FeSiO₄ and Li₂MnSiO₄, rock salt layer-type active materials such as LiNi_{0.8}Co_{(0.2-x)}AlₓO₂ (0<x<0.2) in which a part of the transition metal is substituted with a dissimilar metal, spinel-type active materials such as Li₁₊ₓMn_{2-x-y}M_{y}O₄ (M is at least one of Al, Mg, Co, Fe, Ni, and Zn, and 0<x+y<2) in which a part of the transition metal is substituted with a dissimilar metal, and lithium titanates such as Li₄Ti₅O₁₂.

The sulfide active material may suitably include copper chevrel, iron sulfide, cobalt sulfide, nickel sulfide, or the like.

The solid electrolyte may suitably include an oxide solid electrolyte or a sulfide solid electrolyte. However, it may be preferable to use a sulfide-based solid electrolyte having high lithium ion conductivity. The sulfide-based solid electrolyte is not particularly limited, but examples thereof may suitably include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (provided that m and n are positive numbers, and Z is one of Ge, Zn, and Ga), Li₂S—GeS₂, Li₂S—SiS₂—Li₃PO₄, Li₂S—SiS₂—LiₓMO_{y} (provided that x and y are positive numbers, and M is one of P, Si, Ge, B, Al, Ga, and In), Li₁₀GeP₂S₁₂, etc.

The conductive material may suitably include carbon black, conductive graphite, ethylene black, graphene, or the like.

The binder may suitably include butadiene rubber (BR), nitrile butadiene rubber (NBR), hydrogenated nitrile butadiene rubber (HNBR), polyvinylidene difluoride (PVDF), polytetrafluoroethylene (PTFE), carboxymethylcellulose (CMC), or the like.

The solid electrolyte layer 30 may be positioned between the anode 10 and the cathode 20 to allow lithium ions to move between both components.

The solid electrolyte layer 30 may suitably include an oxide-based solid electrolyte or a sulfide-based solid electrolyte. However, it may be preferable to use a sulfide-based solid electrolyte having high lithium ion conductivity. The sulfide-based solid electrolyte is not particularly limited, but examples thereof may include Li₂S—P₂S₅, Li₂S—P₂S₅—LiI, Li₂S—P₂S₅—LiC1, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (provided that m and n are positive numbers, and Z is one of Ge, Zn, and Ga), Li₂S—GeS₂, Li₂S—SiS₂—Li₃PO₄, Li₂S—SiS₂—LiₓMO_{y} (provided that x and y are positive numbers, and M is one of P, Si, Ge, B, Al, Ga, and In), Li₁₀GeP₂S₁₂, etc.

The anode current collector 40 may be a plate-shaped, sheet-shaped, or thin substrate composed of a material having conductivity. The material constituting the anode current collector 40 is not particularly limited, but examples thereof may include copper (Cu), nickel (Ni), stainless steel (SUS), etc.

The cathode current collector 50 may be a plate-shaped, sheet-shaped, or thin substrate composed of a material having conductivity. The material constituting the cathode current collector 50 is not particularly limited, but examples thereof may include aluminum (Al), stainless steel (SUS), etc.

The method for manufacturing an anode for an all-solid-state battery may comprise the steps of: preparing a slurry including a carbon-based material-containing anode active material, a solid electrolyte, and a binder; and forming an anode by applying the slurry onto a substrate.

Since the anode active material, the solid electrolyte, and the binder have been described above, the descriptions thereof will be omitted hereinafter.

The slurry may be prepared by introducing the anode active material, the solid electrolyte, and the binder into a solvent.

The type of the solvent is not particularly limited, and any solvent may be used as long as the solvent does not react with the solid electrolyte while enabling the anode active material, the solid electrolyte and the binder to be dispersed. For example, the solvent may be hexyl butyrate.

A method for applying the slurry is not particularly limited, and may be performed by a method such as spin coating.

### EXAMPLE

Hereinafter, another embodiment of the present invention will be described in more detail through Examples. The following Examples are merely illustrative to help the understanding of the present invention, and the scope of the present invention is not limited thereto.

### Example

An anode active material was prepared by depositing silver (Ag), a metal that can form an alloy with lithium, to a thickness of about 50 nm on the surface of graphite, which is a carbon-based material. The anode active material, a sulfide-based solid electrolyte, and a binder were introduced into a solvent to prepare a slurry. The slurry was applied onto an anode current collector to form an anode having a thickness of about 50 Nitrile butadiene rubber (NBR) was used as the binder, and hexyl butyrate was used as the solvent.

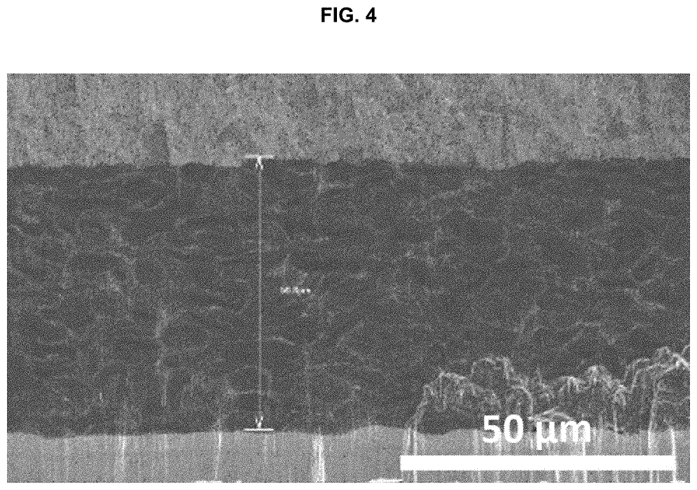

FIG. 4 shows a result of analyzing the anode according to the Example with a scanning electron microscope (SEM). As shown in FIG. 4, a deposition layer formed in the form of a white band on the surface of graphite may be observed.

### Comparative Example

An anode was manufactured in the same manner as in the Example above except that graphite in which a deposition layer as the anode active material was not formed was used.

### Experimental Example 1

Half-cells were constructed by laminating a solid electrolyte layer containing a sulfide-based solid electrolyte on each of the anodes according to the Example and Comparative Example, and laminating lithium metal on the solid electrolyte layer.

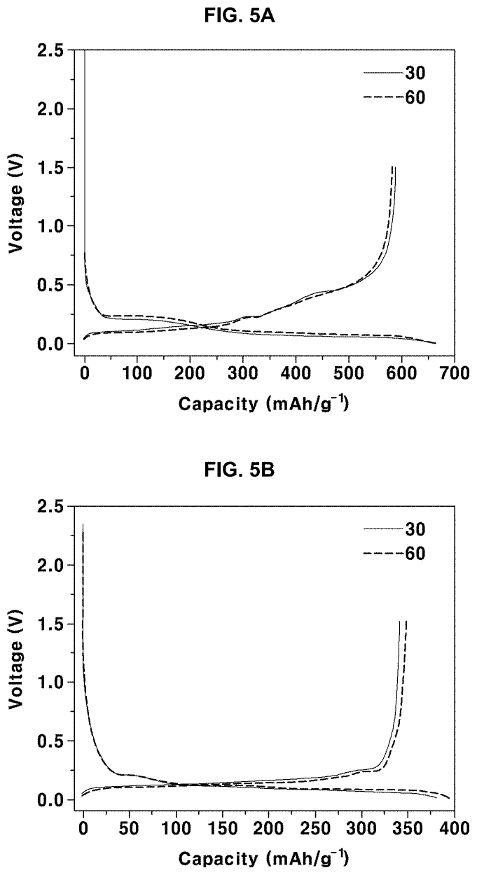

FIG. 5A shows a first charge/discharge graph of the half-cell comprising the anode according to the Example. FIG. 5B shows a first charge/discharge graph of the half-cell comprising the anode according to the Comparative Example. The properties were evaluated at a temperature each of 30° C. and 60° C.

As shown in FIGS. 5A and 5B, the Comparative Example shows a relatively high reactivity in the initial charging reaction (>0.5 V), which is a reaction forming an irreversible resistance layer, and is not seen in the result of the Example.

When evaluated at a temperate of 30° C., the initial efficiency of the Example was about 91.8%, and the initial efficiency of the Comparative Example was about 89.5%. When evaluated at a temperature of 60° C., the initial efficiency of the Example was about 90.0%, and the initial efficiency of the Comparative Example was about 88.2%.

### Experimental Example 2

The charging and discharging characteristics were evaluated in the same manner as in Experimental Example 1 by increasing the current density to 2 mA/cm². The deposition capacity was set to 3.5 mAh/cm².

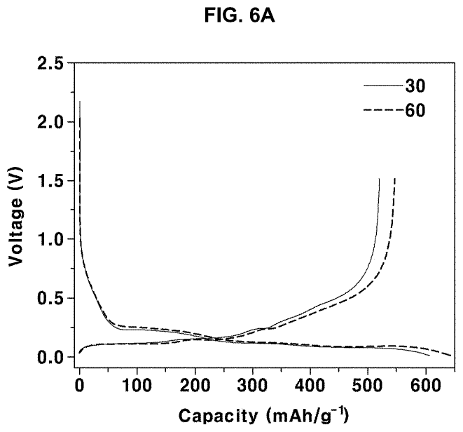

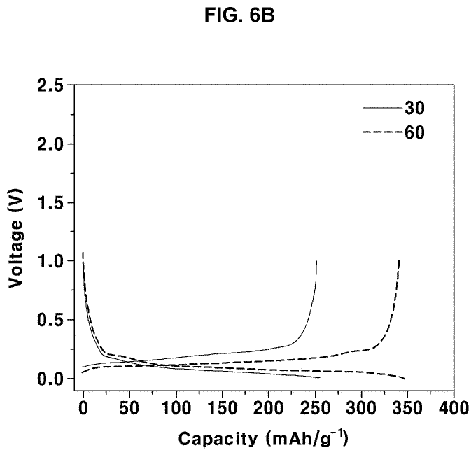

FIG. 6A shows a high rate charge/discharge graph of the half-cell comprising the anode according to the Example. FIG. 6B shows a high rate charge/discharge graph of the half-cell comprising the anode according to the Comparative Example. The properties were evaluated at a temperature each of 30° C. and 60° C.

As shown in FIG. 6B, the Comparative Example shows a large difference in capacity implementation for each temperature. Lithium intercalation was not smooth at low temperatures where lithium movement was limited, which was caused by unsmooth lithium movement between the surface of graphite and the solid electrolyte, and may be accelerated by a resistance layer formed at the interface.

As shown in FIG. 6A, the deviation by temperature of lithium stored by graphite in the Example was rapidly reduced. This is a result of the deposition layer contributing to the movement of lithium into graphite.

### Experimental Example 3

A half-cell was constructed by laminating a solid electrolyte layer containing a sulfide-based solid electrolyte on the anode according to the Example, and laminating lithium metal on the solid electrolyte layer.

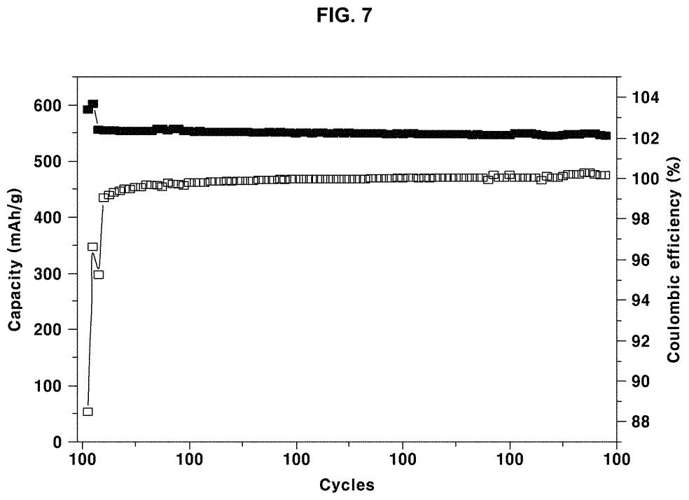

FIG. 7 shows a result of measuring the lifespan of the half-cell comprising the anode according the Example. As shown in FIG. 7, the half-cell of the Example showed stable lifespan behavior and high lifespan efficiency are shown under the evaluation conditions in which lithium was repeatedly subjected to intercalation/deintercalation reactions into graphite through the deposition layer, and at the same time, had very high capacity due to the introduction of the deposition layer. This may be interpreted as a stable result compared to the rapid short circuit of the battery due to lithium dendrites deposited on the surface of the solid electrolyte when the battery was driven using only graphite as an anode active material.

As the exemplary embodiments of the present invention have been described in detail above, the right scope of the present invention is not limited to the above-described embodiments, and various modifications and improved forms by those skilled in the art using the basic concept of the present invention as defined in the following claims are also included in the right scope of the present invention.

What is claimed is:

1. An anode for an all-solid-state battery, comprising:
an anode active material comprising a carbon-based material; and
a solid electrolyte,
wherein the anode active material comprises a deposition layer comprising a metal that can form an alloy with lithium and formed on at least a portion of the surface of the carbon-based material.

2. The anode of claim 1, wherein the anode active material comprises a deposition layer formed on at least a portion, which is in contact with the solid electrolyte, of the surface of the carbon-based material.

3. The anode of claim 1, wherein the solid electrolyte comprises a sulfide-based solid electrolyte.

4. The anode of claim 1, wherein the deposition layer is deposited on a surface corresponding to at least about 90% of the entire surface of the carbon-based material.

5. The anode of claim 1, wherein the deposition layer has a thickness of about 10 nm to 300 nm.

6. The anode of claim 1, wherein the metal that can form an alloy with lithium comprises one or more selected from the group consisting of silver (Ag), magnesium (Mg), aluminum (Al), gallium (Ga), zinc (Zn), bismuth (Bi), tin (Sn), indium (In), antimony (Sb), lead (Pb), silicon (Si), and germanium (Ge).

7. The anode of claim 1, further comprising a binder.

8. The anode of claim 7, wherein the anode comprises an amount of about 80% by weight to 85% by weight of the anode active material, an amount of about 10% by weight to 15% by weight of the solid electrolyte, and an amount of about 1% by weight to 5% by weight of the binder, based on the total weight of the anode.

9. The anode of claim 1, wherein the anode has a thickness of about 1 μm to 100 μm.

10. An all-solid-state battery comprising:
the anode of claim 1;
a cathode; and
a solid electrolyte layer positioned between the anode and the cathode.

11. A method for manufacturing an anode for an all-solid-state battery, comprising:
preparing a slurry comprising an anode active material including a carbon-based material, a solid electrolyte, and a binder; and
forming an anode by applying the slurry onto a substrate,
wherein the anode active material comprises a deposition layer comprising a metal that can form an alloy with lithium and formed on at least a portion of the surface of the carbon-based material.

12. The method of claim 11, wherein the anode active material comprises a deposition layer formed on at least a portion, which is in contact with the solid electrolyte, of the surface of the carbon-based material.

13. The method of claim 11, wherein the solid electrolyte comprises a sulfide-based solid electrolyte.

14. The method of claim 11, wherein the deposition layer is deposited on a surface corresponding to at least 90% of the entire surface of the carbon-based material.

15. The method of claim 11, wherein the deposition layer has a thickness of 10 nm to 300 nm.

16. The method of claim 11, wherein the metal that can form an alloy with lithium comprises one or more selected from the group consisting of silver (Ag), magnesium (Mg), aluminum (Al), gallium (Ga), zinc (Zn), bismuth (Bi), tin (Sn), indium (In), antimony (Sb), lead (Pb), silicon (Si), and germanium (Ge).

17. The method of claim 11, wherein the anode comprises an amount of about 80% by weight to 85% by weight of the anode active material, an amount of about 10% by weight to 15% by weight of the solid electrolyte, and an amount of about 1% by weight to 5% by weight of the binder, based on the total weight of the anode.

18. The method of claim 11, wherein the anode has a thickness of about 1 μm to 100 μm.

19. A vehicle comprising an all-solid-state battery of claim 10.
